(19) United States
(12) Patent Application Publication
(10) Pub. No.: US 2006/0129975 A1
(43) Pub. Date: Jun. 15, 2006

(54) Measuring method and automatic pattern recognition system for determining a business management related characteristic vector of a knowledge object and method and automatic system for the automatic business management related characterization of a knowledge object

(75) Inventors: Kai Wille, Kempen (DE); Jens Kiefel, Kempen (DE); Fouad Hamdouni, Duisburg (DE)

Correspondence Address: LERNER GREENBERG STEMER LLP, P O BOX 2480, HOLLYWOOD, FL, 33022-2480, US

(73) Assignee: Centrum für Ertragsoptimierung Aktiengesellschaft

(21) Appl. No.: 11/344,817

(22) Filed: Feb. 1, 2006

Related U.S. Application Data
(63) Continuation of application No. PCT/EP03/08512, filed on Aug. 1, 2003.

(51) Int. Cl. G06F 9/44

(52) U.S. Cl. 717/108; 717/106

(57) ABSTRACT

The invention relates to a measuring method for determining a business management related characteristic vector of a knowledge object, taking into consideration soft parameters, by using an electronic data processing system, with a memory and a characteristic-vector generator for generating the characteristic vector. The method includes an initiation step, which predetermines a base consisting of a multiplicity of basic vectors and inputs the base into the memory. The method also includes carrying out a projection step in which the characteristic-vector generator projects the knowledge object onto the basic vectors and determines the business management related characteristic vector as coordinate vector with respect to the base.

### CROSS-REFERENCE TO RELATED APPLICATION

This is a continuing application of PCT/EP2003/008512, filed Aug. 1, 2003, which is herewith incorporated by reference in its entirety.

### BACKGROUND OF THE INVENTION

Field of the Invention:

The invention relates to a measuring method for determining a business management related characteristic vector of a knowledge object, taking into consideration soft parameters, and to a method for the automatic business management related characterization of a knowledge object and to the devices suitable for carrying out this method.

It is known that due to the increasing interdependence of national economies and enterprises as part of the globalization and the associated intensification of the competition on the goods and services markets, enterprises are today subjected to a strong pressure to critically look at their own requirements and performances so that they can continue to survive in competition. For example, large enterprises in the form of concerns are particularly subject to this pressure since, on the one hand, a rapidly changing environment requires an increasing measure of flexibility of the enterprise and, on the other hand, large and diversified structures which provide relative security against economic risks lead to a certain inertia in carrying out new decisions. For this reason, large enterprises are particularly interested in exploiting their own potentials within the enterprise to a better extent.

Against this background, potential competitive advantages are sought within the enterprise which, on the one hand, generate better products and, on the other hand, more satisfied customers. Apart from this focus directed at the sales market, the finding is increasingly gaining ground that competitive advantages can also be found in internal structures, especially in the employed staff members of the enterprise who, with their work, are responsible for the continued existence of the enterprise. In this context, the intellectual capital of these staff members has a fundamental significance for the enterprise. Accordingly, the exploitation of the intellectual capital of the staff members represents the central challenge for future positioning in competition for many enterprises.

Covered by the term “knowledge management”, this problem is accorded the highest priority in science and practice. It has been found that knowledge has a considerable significance as a production factor and knowledge is considered to be one of the most important sources of value creation for enterprises with highly diversified structures.

When looking more closely at the methods of knowledge management applied, a systematic approach has hitherto been lacking.

In spite of many different attempts to systematically track and secure knowledge potentials in enterprises, the boundaries of current knowledge management become quickly apparent. On the one hand, it becomes clear that systematic knowledge management must not stop at the boundaries of a rigidly hierarchically structured organization and, on the other hand, there have hitherto been insurmountable barriers on the part of the staff members which lead to a lack of sharing the respective knowledge potentials. The knowledge of the staff member is often used as a strategic factor for succeeding in enterprises instead of employing it for the benefit of the whole organization. This problem of self interested behavior of a large proportion of the staff members is inherent in many previous concepts of knowledge management. Although there is extensive knowledge in databases inside and outside of enterprise, it is often not possible or too complicated to access this knowledge.

The boundaries of the previous knowledge management concepts listed can be advantageously dissolved by an innovative market-oriented approach of knowledge management. Markets are then generally characterized by the interaction of supply and demand. As part of this approach, knowledge is offered in the form of products on internal markets of the organization. On these markets, possession of knowledge is to be transferred completely in its essence to the demander.

If the knowledge offered is needed at another location in the enterprise, that is to say encounters a demand, a transaction of the product of knowledge is performed. Possession of the knowledge offered is transferred to the demander and the supplier receives a purchase price which is determined either by a bidding competition or by a “price ticket” by the supplier. The possibility of earning money with one's own knowledge would provide a strong stimulus for making one's own knowledge potentials accessible to the enterprise. Furthermore, the knowledge is directed to the location in the enterprise where it is most needed. It must, therefore, be assumed that the market distribution of knowledge effected is optimal for the enterprise.

The introduction of the concept necessarily presupposes the creation of market structures in enterprises. From a technical point of view, these market structures are only becoming possible due to the more recent development of information and communication techniques. In the field of electronically based commerce (e-Commerce), for example, high turnovers have been achieved for some years. The high transparency of the products offered, which enables the demander to obtain a sound overview of the products offered, has proven to be an advantageous factor here. There are no costs for procuring the products since, in most cases, these are delivered by commissioned logistics enterprises following the transaction. In the sense of the “price ticket” described above, examples of Internet-based market platforms are Internet shops in which products are offered at fixed prices and quantity discounts can also be taken into consideration when the demand rises. In the meantime, market platforms in which no fixed prices are predetermined but are created by bids from the demanding side are common especially in the context of Internet auctions.

Knowledge markets differ from the traditional goods markets in many ways, the reason being, among other things, the special characteristic of the merchandise knowledge. Since knowledge can be considered as context-dependent to a particular extent, i.e. is only used in connection with pre-existing knowledge, it is in most cases not possible to offer fixed products of identical content on knowledge markets as is common with material goods. Nevertheless, there is a necessity for characterizing the product of knowledge since otherwise a potential demander will not have any clarity about the extent to which he can use the knowledge. Correspondingly, the traded products of knowledge must be allocated to product groups which allow an unambiguous identification. A further distinction with respect to traditional markets consists in the characteristic of dividability of the knowledge or copyability of the knowledge, i.e. that knowledge can be arbitrarily combined and passed on without any loss of knowledge occurring at the previous bearer. This special characteristic gives rise to a necessity of eliminating an inadmissible re-sale of acquired knowledge by means of technical provision.

Since on the basis of these observations, it is more likely that special products are offered on knowledge markets in enterprises, it can be expected that the number of demanders for a product of knowledge offered is likely to be low, as a rule. This correspondingly has the result that the functionality of knowledge markets within organizations cannot be defined in the traditional sense. Instead, knowledge markets will primarily be so-called “matching markets” which are intended to bring together supply and demand. It must be assumed that functioning knowledge markets can only arise in enterprises when sufficient transparency about what products are being offered at all is created in the enterprise.

The effectiveness of the implementation of knowledge management can be measured on the degree of this transparency. The creation of this transparency hitherto required highly qualified personnel which assembles, classifies, groups and edits the knowledge in an enterprise. The disadvantageous factor here, however, was that this resulted in extensive costs with only moderate transparency being achieved. In addition, the knowledge was frequently evaluated incorrectly and appropriately offered on the internal market of the organization if the personnel commissioned with the evaluation of the knowledge was not familiar with the content of the material. Due to the subjective character in the evaluation of the knowledge by an individual or a group of individuals, it was not possible to satisfactorily establish transparency for the knowledge.

### SUMMARY OF THE INVENTION

It is thus the object of the present invention to create a measuring method and an automatic pattern recognition system for evaluating knowledge so that large amounts of knowledge can be evaluated in accordance with predetermined criteria. Furthermore, a method and an automatic system are to be specified by means of which knowledge can be quantified and/or provided as an offer on internal knowledge markets of an organization.

This object is achieved by a measuring method having the features of claim 1, by a method for the automatic business management related characterization of a knowledge object, having the features of claim 8, by an automatic pattern recognition system having the features of claim 16 and by an automatic system for the automatic business management characterization, having the features of claim 21. Further advantageous embodiments and developments which in each case can be applied individually or arbitrarily combined with one another are the subject matter of the respectively or dependent claims.

The measuring method according to the invention for determining a business management related characteristic vector of a knowledge object, taking into consideration soft parameters, by using an electronic data processing system, with a memory and a characteristic-vector generator for generating a characteristic vector, comprises an initiation step in which a base consisting of a multiplicity of basic vectors is predetermined and input into the memory, and a projection step in which the characteristic-vector generator projects the knowledge object onto the basic vectors and determines the business management related characteristic vector as coordinate vector with respect to the base.

Using this measuring method, information contained in a knowledge object is quantified with regard to business management, soft parameters being taken into consideration.

A knowledge object represents a largely unordered quantity of information in digitally codified form. The information can comprise individual or collective knowledge. In this regard, collective knowledge is no longer distinguished by the fact that it can be unambiguously attributed to a particular bearer (individual). Individual knowledge is characterized by its unambiguous attribution to a particular bearer (individual). Thus, a knowledge object represents a loose set of mainly unedited information.

A process object is a special subform of the knowledge objects. In particular, it contains business management information and know-how. It exhibits a goal oriented characteristic, i.e. the process object pursues a business management goal, for the pursuance of which instructions to act are given. The term know-how is understood to be individual or collective knowledge which is combined with the organization or performance of one's own work in a business management process. A business management related characteristic vector of a process object is advantageously determined. Process objects represent a particular subgroup of the objects of knowledge which have special knowledge contents which, in turn, exhibit a particular knowledge structure. To measure these objects of knowledge has hitherto presented a particular problem which requires a particular technical solution.

The external form of knowledge or process objects are, in particular, independent computer files which, if necessary, comprise a number of embedded file objects such as, e.g. graphics, tables, text documents etc. Due to its arbitrary form, the knowledge or process object is not suitable for being traded on a market place. This requires an external form, particularly certain evaluation quantities which provide information on the content and on the goal pursued by means of the content. In the case of a process object, the goal pursued by means of the content is, for example, the goal which is pursued by means of a process considered.

The knowledge object or the process object, respectively, thus contains generally both hard and soft parameters.

Hard parameters are objective criteria which can be quantified in a simple manner due to their discrete information content. Examples include: number of graphical overviews, number of process phases, number of formulated operating steps (to-dos), enhancing steps, number of attached files with how up-to-date they are in each case, size, type etc., process duration (ex post), numbers, formats etc. In this connection, discrete means that the parameters as such have a format or a form, respectively, so that the individual parameter can be easily used or processed further, respectively.

Soft parameters are quasi-objective criteria which, due to their format or their form, respectively, must first be interpreted so that they can then be processed further and used. Soft parameters have the characteristic of having a certain information fuzziness due to their form to be interpreted. This fuzziness is only overcome when a quantizing measure is found which suitably quantifies the formless soft parameter. Examples of soft parameters in process objects are the so-called customer equity value (CE value), customer satisfaction, customer potential, future perspectives etc.

While hard parameters can be acquired in a simple manner by means of a raster, the evaluation of soft parameters requires a minimum amount of logical thinking, i.e. intelligence.

The measuring method according to the invention evaluates the knowledge or process object with regard to predetermined business management criteria. These are predetermined during the initiation step in that a base is determined. The basic vectors of the base span an information space. The measuring method determines the locations of the parameters of the knowledge object in this information space. Especially for process objects, the measuring method represents an intensity sensor for know-how in the respective dimensions of the basic vectors which are predetermined by the business management criteria.

The basic vectors represent basic units which can be arbitrarily combined with one another and span the information space. Basic vectors can be, for example, technical terms, combinations of technical terms, logical relations, syntactic structures of a text, concepts etc . . . The basic vectors are advantageously in each case selected independently of one another. In this manner, a characteristic of a parameter is only covered by one basic vector and not by several at the same time. If the knowledge object contains a number of different parameters, the knowledge object is represented by a number of basic vectors.

In the projection step, the knowledge object is projected onto the basic vectors. In other words, the proportion of basic vectors in the knowledge object is found. The coordinate vector is determined with respect to the base analogously to the projection of a point in a three-dimensional space onto the X, Y and Z axis. The coordinate vector thus depends on the choice of base.

Advantageously, a complete base is selected which spans an information space in which the knowledge object can be represented. In the case of an incomplete base, information contained in the knowledge object will not be represented and thus not be completely taken into consideration. If, for example, basic vectors taking into consideration the investment remain unconsidered during the measurement of business management criteria, parameters relating, e.g. to a special type of investment, cannot be taken into consideration in the measurement since the base is not suitable for representing these parameters. On the other hand, it is appropriate to restrict the base to a limited set of meaningful basic vectors since the computing time of the data processing for determining the characteristic vector, i.e. the response time of the measuring method, thus remains limited. Due to the limited set of basic vector, a filtering also takes place which, for example, takes into consideration only the business management related parameters of the process object and not the non-business-management related parameters. Due to the filtering, the information relevant in a business management context is separated from other information.

A characteristic vector can comprise, for example, among other things, the number of certain terms, numbers relating to particular facts, descriptive information such as adjectives, colors and/or rank lists, as entries. The characteristic vector reproduces the information in the knowledge object ordered in accordance with certain criteria being predetermined by the basic vectors, i.e. categorized. It thus characterizes and categorizes the knowledge product.

Thus, the sensitivity of the measuring method with respect to the information contained in a knowledge object is specified by means of the initiation step. In measuring technology, this corresponds to the choice of locations at which a particular quantity to be measured (e.g. temperature) is to be measured.

In the projection step, the actual measurement of the information content of the knowledge object takes place in that the knowledge object is projected onto the base and the coordinate vector is determined with respect to the base. For example, a particularly good match of a parameter in the knowledge object with a base vector produces a particularly s large entry in the coordinate vector at the point which is responsible for the relevant base vector. The business management related characteristic vector is formed by the coordinate vector.

The knowledge object is measured with regard to business management related information contents by predetermining a suitable base. The knowledge object thus represents a polydimensional quantity which, with the aid of the method according to the invention, is measured in its components which are defined with regard to a base.

The measuring method operates without intervention of activity of the human intellect. Projecting the knowledge object onto the predetermined base results in a particularly simple and clear representation of the knowledge object since the knowledge object is specified in the standardized form of the base. Since other parameters contained in the knowledge object are separated from the business management related parameters, the knowledge object is reduced to comparatively few entries of a business management related characteristic vector. Thus, the measuring method produces an overall reduction in information (entropy reduction), creating transparency, in favor of a business management related concentration of information. The concentration of information requires active energy-consuming processing by a data processing system, e.g. a computer.

In an advantageous development of the measuring method according to the invention, a filter determines the frequency of hard parameters in the knowledge or process object and the characteristic-vector generator takes this frequency into consideration in the determination of the characteristic vector. As a result, hard parameters are also taken into consideration in the determination of the business management related characteristic vector.

The base and/or the process object is advantageously generated at least partially with the aid of a digital, particularly interactively digital, measuring head.

Digital measuring heads can be search engines which filter out the information that is relevant for the business management process from large databases, e.g. the Internet, by suitable programming. A digital measuring head is thus frequently an automatic system which has the instruction of searching through databases under predetermined criteria and delivering the data found at the required place. Digital measuring heads can also be used for recording a demand vector.

Digital measuring heads can also use an interactively acting voice computer which uses audio signals for recording knowledge contents independently and in a goal-oriented manner.

In addition, digital measuring heads can also use avatars (linguistic robots). An avatar is understood to be a visually configured virtual user interface which records, selects and combines knowledge contents independently and in a goal-oriented manner.

The basis both for an avatar and for a digital measuring head are organized knowledge databases in the form of special computer files. Knowledge database in this context means a logically combined database on which knowledge can be stored and selectively called up for avatars or digital measuring heads, respectively. The knowledge databases comprise knowledge modules. A knowledge module represents a document (e.g. in the form of a computer file), the content of which reproduces or explains individual and/or collective knowledge.

It is of advantage if the characteristic-vector generator preferably performs a correlation of the base with the process object. In this process, the characteristic-vector generator compares each parameter of the process object with the basic vectors and determines the degree of correspondence.

The characteristic-vector generator advantageously performs a word comparison between the knowledge object and the base. In the process, the basic vectors are formed by technical terms and a frequency of the technical terms occurring in the process object is determined. For example, an absolute frequency of a parameter such as e.g. a technical term in the process object can be determined, or a relative frequency (frequency density) which determines the proportion of a parameter relative to the total number of parameters occurring. Conditioned frequencies, i.e. frequencies of a parameter in the context of other parameters can also be determined. For example, the number of coincidences of two technical terms within a section of a text can be determined.

In a special embodiment of the measuring method according to the invention, the characteristic-vector generator performs a correlation, weighted with a weighting function, of the base with the knowledge object. For example, certain basic vectors (e.g. individual business management terms) can be weighted more strongly by this means if they are of particular relevance for the business management process, or less if they only have peripheral significance for the business management process. In this context, the characteristic-vector generator determines a correlation density between two parameters.

In the method according to the invention for the automatic business management related characterization of a knowledge object, at least one reference code, at least one business management related characteristic vector, and at least one business management related goal vector is allocated to the. knowledge object and the business management related characteristic vector is determined automatically, taking into consideration soft parameters of the knowledge object. In particular, the business management related characteristic vector is determined in accordance with the measuring method according to the invention.

Using the method according to the invention for the automatic business management characterization, a standardized, transparent knowledge product which, for example, can be presented in a forum, is created from a knowledge object, i.e. from an unedited set of information. The knowledge product is preferably presented internally in the organization, particularly internally in the enterprise, optionally also across the organization and particularly across the enterprise, or publicly, respectively, as a result of which it can be presented and sold on markets inside and outside the organization.

The term “knowledge product” is understood to be knowledge merchandise, which can be physically or virtually delimited at a point in time, with fully specified rights of disposal and a standardized characterization about the knowledge stored in it. The marketability of the knowledge product is a result of the complete precise definition of the defined characteristics of the knowledge product which has taken place. The method conveys information about the access to knowledge, i.e. about the locations at which knowledge is available. The knowledge object characterized by means of the method is advantageously a process object.

The reference code establishes the reference by name of the knowledge object to the source, particularly to the creator of the knowledge object. As a result, a potential user or purchaser of the knowledge product finds out from whom he is obtaining the information.

The business management goal vector specifies the goal of the knowledge object or, respectively, at which the knowledge object is aimed. Whereas the business management related characteristic vector represents information about the content of the knowledge object, the business management goal vector specifies the purpose for which the knowledge object can be used in order to be useful in business management. For example, the goal vector specifies whether this is a sales process. It then advantageously also specifies further information about the type of sales process.

Indicating the business management related characteristic vector or the business management goal vector for a potential user of the knowledge product only makes sense if the user is intended to use the full content of the knowledge product without having to pay for the knowledge product. If the potential user is intended to be a purchaser, for example, a complete disclosure of the process object is not appropriate since, after studying this knowledge product, he will know the process object and will no longer purchase the knowledge product afterward, i.e. after he has acquired the know-how of the process object.

For this reason, it is advantageous that the business management related characteristic vector is not indicated, but only a business management related first code which is formed from the characteristic vector and the goal vector and provides information about the quality and the content of the knowledge product. Although the first code characterizes the knowledge product, the content of the knowledge object as such is not completely disclosed. Using the first code, a potential purchaser of the knowledge product can recognize whether the product is relevant for him and whether he wishes to purchase it or not. He can only gain insight into the knowledge object and use the know-how after the purchase of the knowledge product.

This first code is preferably formed by correlating the characteristic vector and the goal vector. Specifying the first code draws the attention of the purchaser to the relevance of the knowledge product. By correlating the characteristic vector with the goal vector it is found whether the content (characteristic vector) specified in the knowledge object can contribute as a solution to the task (goal vector). If the result is a considerable discrepancy between characteristic vector and goal vector, there is only little trustworthiness for the business management related usefulness for the user. If there is great correspondence, the process object is trustworthy, for example.

Advantageously, a metrics determining means determines a metric function of the characteristic vector as a business management related second code. The metric function of the characteristic vector essentially determines the extent of the business management content of the knowledge object. If, for example, many correspondences of the knowledge object with the basic vectors are found, it can be expected that the business management content of the knowledge object is large. In addition, special combinations of basic vectors allow a special business management related significance to be inferred. The metric function is thus a measure of the business management content of the knowledge object.

As a measure of the metric function, the metrics determining means determines the length of the characteristic vector. The greater the length of the characteristic vector, the more correspondences of the knowledge object with basic vectors have been found. In this metric function, the absolute content of the knowledge object is determined cumulatively.

The metrics determining means can also determine the number of entries in the characteristic vector which are in each case located within a predeterminable interval. For example, only entries which are greater than a particular value are taken into consideration in the characteristic vector. By this means, parameters in a knowledge object can be selectively filtered or weighted in accordance with their business management related significance. Using this metric function, only the content of the knowledge object is determined differentiated with respect to the entries of the characteristic vector.

In an advantageous embodiment of the method according to the invention, the goal vector exhibits entries for the quantitative and qualitative characterization of the knowledge object. Entries for the qualitative characterization of a process object are, for example, customer ties, CE value, etc . . . Entries for the quantitative characterization are, e.g. costs, volume of turnover, cash flow etc . . .

In a particularly advantageous embodiment of the method according to the invention, an identification code is automatically issued to the knowledge object. The transaction, i.e. the purchase of the knowledge product, is individualized by means of this identification code. For example, the purchase can be analyzed in the case of defects or disturbances in performance and thus the purchase of the knowledge product can be cancelled after the event, if necessary. The identification code can also be used for implementing a copy protection for the knowledge product.

In a development of the method according to the invention, the first code and/or the second code is/are determined in dependence on a demand vector. The demand vector characterizes the demand of a purchaser, i.e. the goals pursued by him with the purchase of the knowledge product. The purchaser can specify, for example, what problem fields are to be covered, for what he needs information, which are his major subjects. With the demand vector, the purchaser can specify all criteria important to him when purchasing the knowledge product.

Comparing the demand vector with the characteristic vector establishes whether the knowledge product contains the information wanted by the purchaser. With a high correlation of the demand vector with the characteristic vector, a higher purchase price is advantageously agreed for the knowledge product than in the case of correspondingly lesser correlation.

The automatic pattern recognition system according to the invention for determining a business management related characteristic vector of a knowledge object, taking into consideration soft parameters, particularly by using the measuring method according to the invention, comprises an electronic data processing system, an interface for receiving a base consisting of a multiplicity of basic vectors and for receiving the knowledge object, a memory for storing the base and a characteristic-vector generator for generating the characteristic vector, the characteristic-vector generator exhibiting a projection means for projecting the knowledge object onto the basic vectors and a coordinate-vector generator for determining the business management related characteristic vector as coordinate vector with respect to the base. Advantageously, a characteristic vector of a process object is determined.

A base and a knowledge object are recorded with the aid of the interface. The base consists of a multiplicity of basic vectors, the basic vectors representing individual knowledge elements. The base is stored with the aid of a memory. With the aid of the interface, a demand vector can also be input. The interface can also be used for indicating to the potential user or the purchaser, respectively, a first code, a second code and/or a characteristic vector.

The characteristic-vector generator generates a characteristic vector in which the knowledge object is projected onto the base and the characteristic vector is determined as coordinate vector with respect to the base. With the aid of the characteristic-vector generator, soft parameters are measured, i.e. detected and quantified, in a knowledge object. The characteristic vector specifies the information, projected onto the base, of the knowledge object and thus clearly represents the business management information contained in the knowledge object.

Advantageously, a separate filter for determining the frequency of hard parameters in the knowledge object exists so that hard parameters are also taken into consideration in addition to the soft parameters.

In a development of the invention, a digital, particularly an interactively digital, measuring head is provided for the at least partial creation of the base and/or for inputting the knowledge object and/or for inputting the demand vector. This considerably facilitates the input of the base, of the knowledge object and/or of the process object since the user can be guided by the automatic pattern recognition system during the input. The demand vector can be recorded with the aid of a digital measuring head.

In an advantageous embodiment of the invention, the characteristic-vector generator exhibits a correlator. This correlator is used for advantageously creating a correlation of the soft parameters contained in the knowledge object with the basic vectors of the base so that an overlap or a lack of overlap is determined. The correlator is used for projecting the knowledge object onto the base.

Advantageously, a control means for determining the first code and/or the second code in dependence on a demand vector is provided according to the invention. Using the demand vector, a potential customer can specify what contents should be contained in which form in the knowledge object. Using the control means, the first code and the second code, respectively, are determined tailored individually to him so that he obtains a measure of the relevance of the respective knowledge product by means of the situation presented by him or, respectively, the requirement expressed by him.

The automatic system according to the invention for the automatic business management related characterization of a knowledge object, particularly by using the automatic pattern recognition system according to the invention, comprises a data processing system, an interface for recording a base consisting of a multiplicity of basic vectors and for receiving the knowledge object, a memory for storing the base, a characteristic-vector generator for the automatic generation of a characteristic vector, a reference code generator for issuing a reference code of the knowledge object, and a goal-vector generator for issuing a goal vector of the knowledge object, the characteristic-vector generator exhibiting a projection means for the automatic projection of the knowledge object onto the basic vectors, and a coordinate-vector generator for automatically determining the business management related characteristic vector as coordinate vector with respect to the base.

This automatic system advantageously generates from a knowledge object a knowledge product which shows a potential purchaser what its subject matter is, the goal it is pursuing, for whom it was created. The standardized or transparent form of the knowledge product makes it easier for the potential purchaser to decide whether he wishes to purchase the knowledge product or not. The generation of the characteristic vector characterizes the content of the knowledge object and represents it transparently for a, potential user of the information.

If the information contained in the knowledge object is not to be provided directly to the potential receiver of the information, the automatic system according to the invention preferably has a first code generator by means of which a business management related first code is formed by correlating the characteristic vector with the goal vector. Using this first code, the potential receiver of the information can find out whether the goal specified in the knowledge product is covered by the content of the knowledge product without revealing the content of the knowledge product. Using the first code, he is able to recognize whether a solution to a particular problem is specified. He can use this information as a basis for his decision to purchase.

Advantageously, a metrics determining means for determining a metric function of the characteristic vector additionally exists as a business management related second code. Using the second code, a potential receiver can find out the amount of information contained in the knowledge product. The first and second code, respectively, can be output via the interface.

The automatic system according to the invention advantageously exhibits a so-called ID generator (identification number generator) for automatically issuing an identification number. Issuing an identification number individualizes the purchase of a knowledge product. For example, the purchase can be cancelled or reduced in the case of any defects in the knowledge product. In addition, the identification number can be used for implementing a copy protection which prevents resale of the knowledge product.

Advantageously, the automatic system exhibits a control means for determining the first code and/or the second code in dependence on a demand vector. By this means, a potential purchaser can influence the calculation of the first and second code, respectively, by providing his wishes or criteria which are moving him to purchase a knowledge product, in that the codes are determined individually tailored to him.

In a development of the invention, the measuring method and the automatic pattern recognition system are used for determining a characteristic vector creating information value, and the method and the automatic system are used for automatically characterizing the knowledge object in an information value creating manner. In this process, the business management orientation is generalized in an information value creating regard. In this context, the term information value creating means generalization of any economically, scientifically or culturally relevant business management aspects about which a characteristic vector can or is to be determined.

Further embodiments and advantageous developments are explained with reference to the drawing which follows, which is intended to illustrate but not to restrict the invention.

### BRIEF DESCRIPTION OF THE DRAWINGS

FIG. 1 shows an automatic pattern recognition system according to the invention for determining a business management related characteristic vector of a knowledge object, taking into consideration soft parameters;

FIG. 2 shows an automatic system according to the invention for the automatic business management related characterization of a knowledge object;

FIG. 3 shows a flowchart according to the invention for the automated business management related characterization of process objects;

FIG. 4 shows a flowchart according to the invention for taking stock of the goal of the process object based on the example of a process object from sales;

FIG. 5 shows a flowchart according to the invention for taking stock of the content of the process object;

FIG. 6 shows a flowchart according to the invention for generating the characteristic vector with the aid of an avatar-generated knowledge base;

FIG. 7 shows a flowchart according to the invention for generating the characteristic vector; and

FIG. 8 shows a flowchart according to the invention for determining the optimum code from a pool of codes by checking the trustworthiness.

### DESCRIPTION OF THE PREFERRED EMBODIMENT

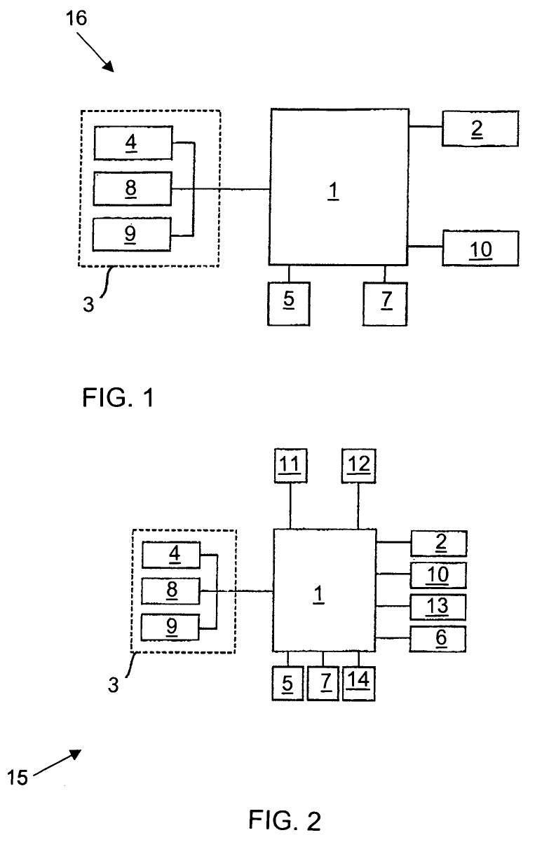

FIG. 1 shows an automatic pattern recognition system 16 according to the invention with a data processing system 1 which is connected to a characteristic-vector generator 3, the characteristic-vector generator 3 exhibiting a filter 4 for determining the frequency of hard parameters in a knowledge object, a projection means 8 for projecting the knowledge object onto basic vectors and a coordinate-vector generator 9 for determining the business management related characteristic vector as coordinate vector with respect to the base.

The knowledge object is input into the automatic pattern recognition system 16 via an interface 7. A digital measuring head 5 facilitates the inputting of a base which is utilized as a basis for the evaluation of the knowledge object with regard to business management contents. The base is stored with the aid of a memory 2. Using the measuring head 5, a demand vector is also additionally input by means of which a characteristic vector can be determined by using a control means 10.

The automatic pattern recognition system 16 projects the knowledge object onto the basic vectors stored in the memory 2 and determines a coordinate vector with respect to the base. The coordinate vector is evaluated with regard to relevant business management related basic elements so that it corresponds to a business management related characteristic vector. In the projection, information contents which are unimportant from the business management point of view are suppressed so that the knowledge object is filtered in a business management respect. Thus, the business management contents are condensed and can thus be represented compactly and clearly by means of a business management related characteristic vector.

By means of the automatic pattern recognition system 16 according to the invention, the business management content of a knowledge object is efficiently measured automatically. The sensitivity and the transfer function of this automatic pattern recognition system 16 is significantly influenced by the prior specification of the base and can thus be tailored within wide areas to the respective problem to which it is to be applied.

FIG. 2 shows an automatic system 15 according to the invention for the business management related characterization of a process object with a data processing system 1 which is connected to a characteristic-vector generator 3 for generating a characteristic vector. The characteristic-vector generator 3 comprises a filter 4 for determining hard parameters in the process object, a projection means 8 for projecting the process object onto the base and a coordinate-vector generator 9 for generating the coordinate vector of the process object with respect to the predetermined base, the coordinate vector being a business management related characteristic vector due to the base selected in accordance with business management points of view.

The data processing system 1 is connected to a reference-code generator 11 by means of which a reference code is issued which specifies from whom the process object originates. The reference code thus specifies the information source or, respectively, the creator of the process object.

In addition, the data processing system 1 is connected to a goal-vector generator 12 by means of which the goal of the process object is predetermined. A goal in this sense is, for example, whether the process object is a sales process. The goal vector is usually generated together with the provider of the process object, but can also be produced at least partially automatically by determining certain codes partially automatically.

The data processing system 1 is also connected to a memory for storing the base, the process object, the demand vector or other quantities. The data processing system 1 determines a first code by correlating the goal vector with the characteristic vector, and a second code which is determined from the characteristic vector. The second code is determined with the aid of the metrics determining means 6. The second code supplies information about the content of the process object.

The first and second code can be influenced with the aid of the control means 10, taking into consideration the demand vector. The first and second code can be used by a potential purchaser for deciding whether the process object is relevant to him and whether he wishes to purchase the knowledge product without the process object being completely disclosed. The two codes are output to the potential purchaser with the aid of the interface 7.

An ID generator 13 issues an identification number to the knowledge product which is created from the process object, so that the purchase of the knowledge product can be duplicated or corrected when defects occur. The identification number also prevents any uncontrolled resale of the knowledge product.

Using a measuring head 5, on the one hand, the input of the base into the memory 2 can be facilitated, and, on the other hand, it can be used for creating a demand vector which characterizes the demand expressed by a potential receiver of the knowledge product. Communication between a potential receiver of the knowledge product and the creator of the process object, respectively, is established with the aid of the interface 7. A code generator 14 is used for quantifying a trustworthiness of the knowledge product in such a manner that a correlation between the characteristic vector and the goal vector, i.e. the predetermined goal and the specified solution, is determined.

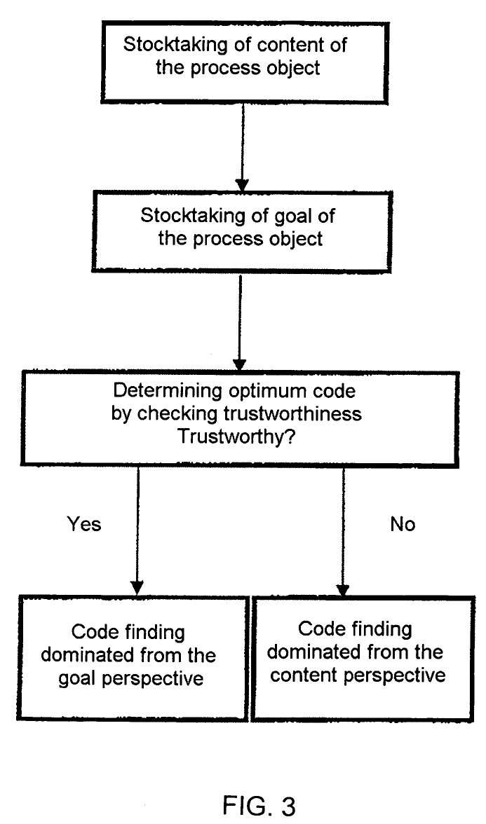

FIG. 3 shows a flowchart, according to which a business management related characterization is automatically effected according to the invention. In this process, the content of the process object is first recorded. Then the goal intended by the process object is recorded. By checking the correspondence between goal and content, it is determined how trustworthy the process object is and an optimum code is determined. If the process object is trustworthy, the code finding is dominated from this perspective. If the process object is less trustworthy, the code finding is dominated from the perspective of content. The second code is advantageously issued together with the first code so that the potential purchaser obtains, in addition to the measure of the content, also a measure of the trustworthiness.

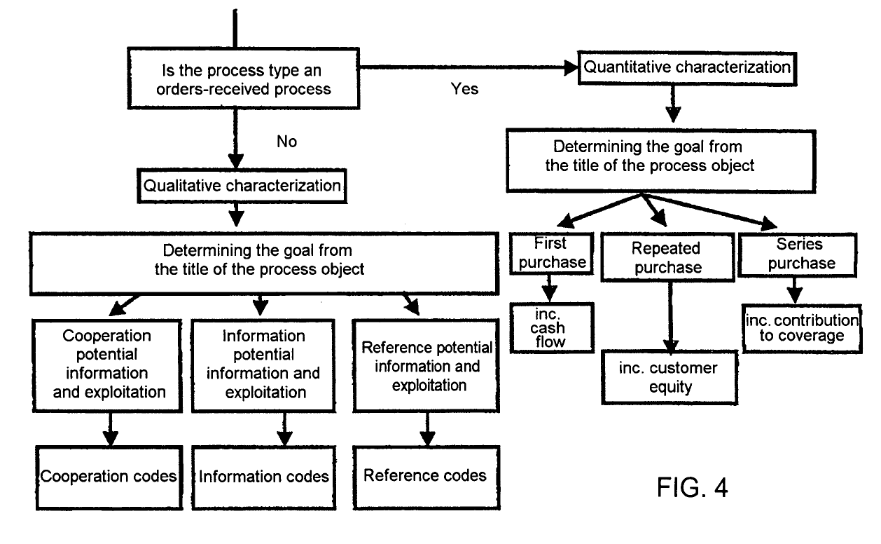

FIG. 4 shows a flowchart for recording the goal of the process object based on the example of a process object from sales according to the invention. In this process, the question is first posed which process type this is. If yes, a quantitative characterization is performed and the goal is determined through the title of the process object. In the case of a first purchase, relevant parameters are, among others, cash flow. In the case of a repeat purchase, relevant parameters are, among others, customer equity. In the case of a series purchase, relevant parameters are, among other things, contribution to coverage.

If it is a matter of a process of orders received, a qualitative characterization takes place, in that the goal is determined by the title of the process object. In this process, the cooperation potential, the information potential and the reference potential are in each case determined in accordance with information and yield and by this means cooperation codes, information codes and reference codes are determined.

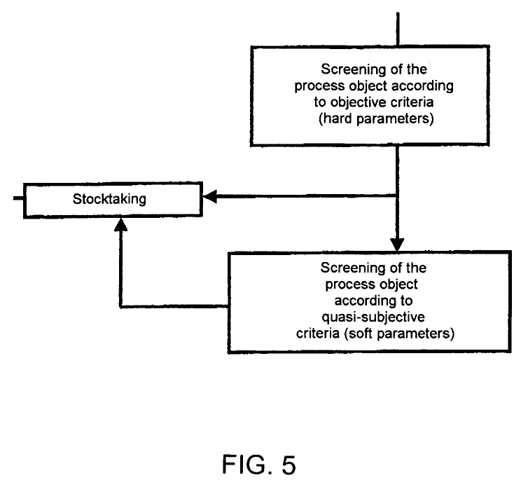

FIG. 5 shows a flowchart for taking stock of the content of the process object according to the invention, the process object first being searched for objective criteria, i.e. hard parameters. Then the process object is searched for quasi-subjective criteria, i.e. soft parameters. Both the objective criteria and the quasi-subjective criteria are covered in the stocktaking.

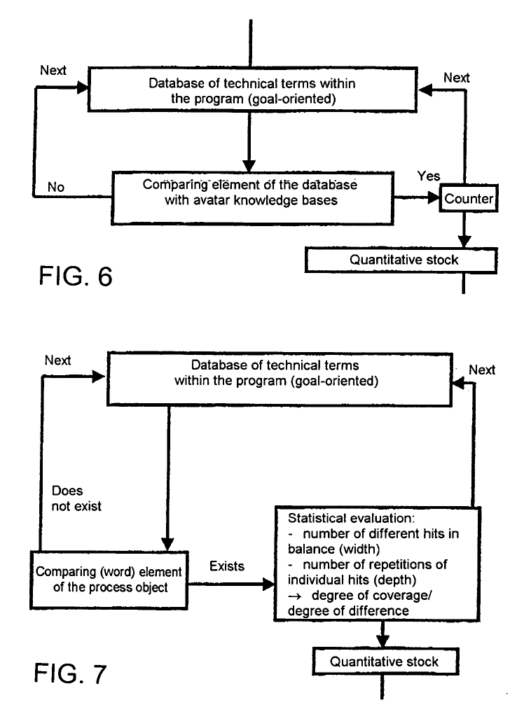

FIG. 6 shows a flowchart for generating the characteristic vector, the base representing a database of technical terms within the program and the process object being compared with elements of this database. The database can be created with the aid of a digitally interactive measuring head (avatar). The number of the positive correlation or correspondence between the elements of the database and the process object are counted and the number of the correspondence is listed as a quantitative amount in the characteristic vector.

FIG. 7 shows a flowchart for generating the characteristic vector, performing a word-based comparison between the process object and the basic vectors of the base. If a match is found, a statistical analysis is performed in which, for example, the number of different hits in the balance (width), the number of repeats of individual hits (depth) are found in order to determine by this means a degree of overlap or degree of difference, respectively, between the basic vectors of the base and the process object. The results are listed as quantitative amount in the characteristic vector.

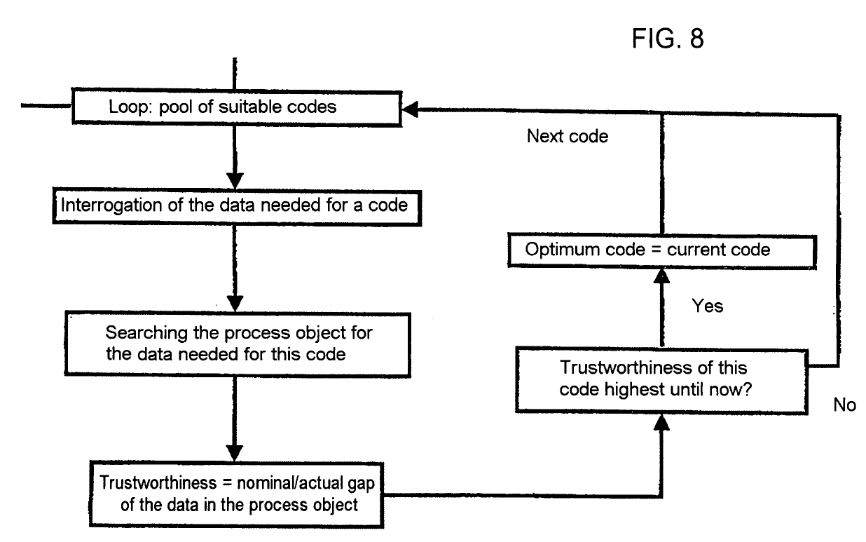

FIG. 8 shows a flowchart according to the invention for determining the optimum code from a pool of codes by checking the trustworthiness of the process object with a loop which searches for a suitable code for the respective process object. The process starts with a first code which starts an interrogation of the data needed. The process object is then searched for the data needed for this code. Following this, the trustworthiness is determined, i.e. the correspondence between the goal of the process object and the content of the process object is determined. If the trustworthiness of this code is the highest until now, the optimum code is determined as the current code. Then the next code is checked. If the trustworthiness of the current code is less than a previous one, the previous code remains the optimum code and a next code is checked.

The invention will be illustrated further in the case example following:

Staff member X works in the sales department of enterprise Y. Enterprise Y is a component of the concern XY. The management of concern XY decides to introduce an internal market in the concern for activating and optimally distributing knowledge potentials among the staff members. All staff members are equipped with a functional application for creating marketable know how.

After beginning work, staff member X logs in directly at his workstation. His user interface is automatically called up on which staff member X has access and overview over the general user environment of the concern and his own user environment via menu control or direct buttons. In the area of the individual user environment of staff member X, there are already some knowledge modules which have hitherto been produced by staff member X:

Using an integrated avatar, staff member X has let himself be interviewed frequently about his work and strategic procedure separated in accordance with type of customers (new customers, regular customers etc.). The results are integrated into the individual knowledge base of the avatar. Some documents available to him have been filtered by an intelligent agent in accordance with key words. The modified documents are also located in his user environment. Staff member X has created various visual documents (statistics, presentations etc.) relating to his work and inserted them into his user environment.

Case i): real-time creation of process objects

Staff member X now decides to create a process object as procedural documentation of his work. The basis is a new project for acquiring a new customer. For this purpose, staff member X sets up a procedural knowledge module in his user environment and, with the aid of the integrated so-called process builder, selects a so-called process map which he considers to be suitable for reproducing his work process. The process map is progressively constructed into a process object in the course of the project. Firstly, staff member X begins with filling out and enhancing the first object template. He provides it with a title and inserts the activity steps to be performed by him. In the course of his work in the first phase, he is exposed to problems which he must solve. His experience and proposals for solving problems are also included by him in the construction of the first object template. Since the user environment contains visual documents which, for example, represent arguments for the choice of his enterprise, he also includes these as second enhancement stage since he expects quite a high price for this arrangement on the internal market of the organization.

Staff member X continuously updates his process object until the end of his project. At the end, he also inserts the surface and knowledge base of his individual avatar with respect to the subject “new customer” into the process object and, by “pressing a button”, creates a marketable knowledge product which he wishes to trade on the internal market of the organization. To identify the knowledge product, the automatic system asks him for origin and title of the product which he specifies as “sales process for acquiring a new customer”. The staff member is then requested to deliver a description of the content and to select a scale for assessing the efficiency of the product. In this context, staff member X selects a quantitative approach which compares costs and yield of the sales process. Finally, staff member X also includes a screen shot as preview for a potential enquirer. After the document has been completed, the integrated individual file can be read within the same application in the sense of staff member X, he enters his document for auction in the internal auction software of the organization.

Case ii): ex-ante creation of process objects

Staff member X decides to market his knowledge about sales processes, which he has built up in years of work, within the organization. For this purpose, he creates a number of procedural knowledge modules which he subdivides in accordance with type of customer (e.g. new customer, regular customer etc.). Then staff member X directly fills out all object templates of the respective process objects and enhances them, on the one hand with collected or produced documents from his user environment and, on the other hand, with the insertion of an avatar and the knowledge bases, belonging to the respective process objects, for the avatar. After completion by pressing on the button and the characterizations already described in case ii), he inserts his process objects for sale in the shop in the organization.

The following exemplary implementation is proposed:

The user interface of an application to be created is to be provided with certain functions which are found to be suitable for achieving the solution to the problem. Firstly, it must be possible to be identified as an individual user (personal log-in). This is of significance since, for creating individual know-how, he must administer a personally protected user area in the form of a user environment.

According to application, a number of requirements now occur. Firstly, the application must be equipped with an avatar which helps the user in producing the process object. The knowledge bases forming the basis of the avatar are subdivided into enterprise-wide general and individualized knowledge bases. Whilst all staff members of the enterprise can access the general knowledge bases, the registered user has exclusive access rights to his own knowledge bases. In this context, the automatic system must be capable of recognizing which user this is and be able to automatically allocate to him the knowledge bases hitherto built up.

The individual knowledge modules are administered via the user himself. The content of these personal knowledge modules can be, for example, any type of computer-aided documents which can either be interlinked or administered in isolation. The user must be able to activate or deactivate certain documents during the program in order to identify knowledge contents already used in knowledge products. Furthermore, this function is used for the personal organization from the workstation if certain documents are no longer needed by the user in the course of time.

Furthermore, the user must be able to produce knowledge modules. In this context, several possibilities for producing knowledge modules must be integrated. Firstly, newly inserted documents can be evaluated fully automatically with the aid of software-based agents by means of artificial intelligence. If the tasks of this agent operating in the background are specified in greater detail, the automatic system analyzes inserted documents for relevant information and stores these as knowledge modules in a separate document within the personal user environment. A further possibility for content production consists in a self interview conducted by the staff member with the avatar. Personal experience and assessments can thus be built up to form a component of his own knowledge base. Finally, the possibility of externally conducted interviews must also be taken into consideration. The knowledge modules obtained in this connection can then be inserted into the individual user environment as required.

A further requirement for the arrangement is represented by the possibility of additionally generating procedural knowledge modules which can be arbitrarily set up by the user. Procedural knowledge modules are the basic scaffold for marketable knowledge products since it is from procedural knowledge modules that the knowledge product, lastly offered on internal markets of the organization, is created in the form of process objects. To set up such procedural knowledge modules, formal phase-oriented “object templates” must be offered, in particular (function of the “process builder” as construction tool), which can be arbitrarily filled out by the user in order to arrive at a real reproduction of the work process experienced by the user. The selected object templates can then be supplemented with arbitrary content from the remaining individual user environment (e.g. in the form of previously produced knowledge modules) so that a combination of the individual knowledge modules must be ensured. The user-defined generation of at least one object template then represents the advantageous foundation for the automatic generation of a process object.

If object templates are selected, the automatic system should also offer a number of possibilities for processing in time. This must provide the possibility of filling out object templates during the running work process (real-time development). This implies that new object templates can be arbitrarily appended to existing ones, and filled out in the course of time. Similarly, an ex-ante generation should also be permissible which allows the work process to be created from memory.

The transformation of the user-defined object templates with arbitrary content into a marketable process object occurs fully automatically on conclusion of the digital representation of contents desired by the user (“content by click”). The software here must firstly be capable of creating from the filled-out object templates with their respective linkages to other documents within the user environment of the staff member, an integrated and transferable file which can be read and interpreted by any user of the same application. Secondly, it must also be able to create a document, if desired by the user, which can be read and interpreted by any user with standardized application. The last thing to be taken into consideration is the depersonalization of sensitive information components (e.g. company logos in the case of presentations, billing addresses, numbers in the case of customer correspondence) which is automatically performed by agents on creation of the transferable file.

Process objects can vary with regard to their quality. This essentially depends on the arrangement of the object templates. There can be several enhancement stages here. On the simplest basis, object templates are simply only lettered in accordance with phase in the form of a graphical “process map” and produced as “naked” process object. A first enhancement stage consists in the description of work contents which have actually taken place (to dos) and allocation to the individual object templates already defined. In this context, there must also be the possibility of filling out further phase-oriented object templates and to use a “super template” as explanation (hierarchical structure). Other possibilities for a first enhancement consist in inserting memoranda or describing possible problems and their solution. A second enhancement stage is reached with the interlinking of individual object templates with documents produced from the own user environment. This may be the addition of written documents, visual statistics, avatar-based databases for explaining the process object, visual/audio documents or also appropriate databases (e.g. customer databases) in digital form. The second enhancement stage is thus of no direct importance for the usability of the process object but creates a potential additional use for an enquirer which will mainly find expression in the level of the price to be transferred.

To guarantee a marketability of the process objects, the automatic system must perform both interactive and automatic characterizations of the process object. The interactive user-defined characterizations include, on the one hand, origin (name/department), title and goal of the process object, and, on the other hand, efficiency characterization of the process object which makes the use of the process object to be acquired clear to a potential enquirer. Several forms must be available for the efficiency characterization in this context. At the quantitative level, specifying a characteristic quantity is of advantage which presents the enquirer with an investment/profitability relation (e.g. the general characteristic of the “return on investment” ROI). At the qualitative level, a verbal description of use is suitable from which it can be unambiguously concluded in how far the process object offered generates a use for the enquirer. The automatic characterizations of the process object serve to prevent inadmissible further marketing after the knowledge has been received. In this connection, the automatic system must append a transaction number in coded form to the process object, in order to be able to track transaction profiles unambiguously at a later time. If desired by the provider, it must additionally also be possible to include visual “screen shots” of the process object into the characterization.

If the advantageous creation of a process object described here is concluded, it can be tied in with the internal marketing process of the organization. In this context, a market platform can be provided technically by the appropriate utilization of an internal intranet of the organization. Since all staff members of a company are connected to this intranet, it can be assumed that all offers are transparent within the enterprise. A suitable surface for internal market processes of the organization are standard applications which reproduce shopping and auction processes. The process objects created are inserted into these surfaces.

The invention relates to a measuring method for determining a business management related characteristic vector of a knowledge object by taking into consideration soft parameters, by using an electronic data processing system 1, a memory 2 and a characteristic-vector generator 3, for generating the characteristic vector and comprises an initiation step in which a base consisting of a multiplicity of basic vectors is predetermined and entered into the memory 2, and a projection step in which the characteristic-vector generator 3 projects the knowledge object onto the basic vectors and determines the business management related characteristic vector as coordinate vector with respect to the base, and an automatic pattern recognition system 16 suitable for performing the measuring method. Furthermore, the invention is related to a method for the automatic business management related characterization of a knowledge object, the knowledge object being associated with at least one reference code, at least one business management related characteristic vector and at least one business management related goal vector, and the business management related characteristic vector being determined automatically by taking into consideration soft parameters of the knowledge object, especially in accordance with the measuring method according to the invention, and an automatic system 15 suitable for performing the method according to the invention. The invention is characterized by the fact that information, particularly information within an enterprise, can be automatically provided transparently so that this information can be exchanged and traded as knowledge product.

We claim

1. A measuring method for determining a business management related characteristic vector of a knowledge object, taking into consideration soft parameters, by using an electronic data processing system, with a memory and a characteristic-vector generator for generating the characteristic vector, the method which comprises:
predetermining an initiation step in which a base consisting of a multiplicity of basic vectors and inputting the base into the memory;
carrying out a projection step in which the characteristic-vector generator projects the knowledge object onto the basic vectors and determines the business management related characteristic vector as coordinate vector with respect to the base.

2. The measuring method according to 1, wherein a filter determines the frequency of hard parameters in the knowledge object and the characteristic-vector generator takes this frequency into consideration in the determination of the characteristic vector.

3. The measuring method according to claim 1, wherein the base and/or the knowledge object are generated at least partially with the aid of a digital, particularly interactively digital, measuring head.

4. The measuring method according to claim 1, wherein the characteristic-vector generator performs a correlation of the base with the knowledge object.

5. The measuring method according to claim 4, wherein the characteristic-vector generator performs a word comparison between the knowledge object and the base.

6. The measuring method according to claim 4, wherein the characteristic-vector generator performs a correlation, weighted with a weighting function, of the base with the knowledge object.

7. The measuring method according to claim 4, wherein the characteristic-vector generator determines a correlation density.

8. A method for the automatic business management related characterization of a knowledge object, the knowledge object being associated with
at least one reference code,
at least one business management related characteristic vector, and
at least one business management related goal vector,
and the business management related characteristic vector being determined automatically, taking into consideration soft parameters of the knowledge object in accordance with the measuring method according to claim 1.

9. The method according to claim 8, wherein a business management related first code is formed from the characteristic vector and the goal vector in that the characteristic vector and the goal vector are correlated.

10. The method according to claim 8, wherein a metrics determining means determines a metric function of the characteristic vector as a business management related second code.

11. The method according to claim 10, wherein the metrics determining means determines the length of the characteristic vector.

12. The method according to claim 10, wherein the metrics determining means determines the number of entries in the characteristic vector which are in each case located within a predeterminable interval.

13. The method according to claim 8, wherein the goal vector exhibits entries for the quantitative and qualitative characterization of the knowledge object.

14. The method according to claim 8, wherein an identification code is automatically issued to the knowledge object.

15. The method according to claim 8, wherein the first code and/or the second code is/are determined in dependence on a demand vector.

16. An automatic pattern recognition system for determining a business management related characteristic vector of a knowledge object, taking into consideration soft parameters, comprising
an electronic data processing system,
an interface for receiving a base consisting of a multiplicity of basic vectors and for receiving the knowledge object,
a memory for storing the base, and
a characteristic-vector generator for generating the characteristic vector;
the characteristic-vector generator including:
a projection means for projecting the knowledge object onto the basic vectors, and
a coordinate-vector generator for determining the business management related characteristic vector as coordinate vector with respect to the base.

17. The automatic pattern recognition system according to claim 16, comprising a filter for determining the frequency of hard parameters in the knowledge object.

18. The automatic pattern recognition system according to claim 16, comprising a digital, particularly interactively digital, measuring head for the at least partial creation of the base and/or input of the knowledge object.

19. The automatic pattern recognition system according to claim 16, wherein the characteristic-vector generator includes a correlator.

20. The automatic pattern recognition system according to claim 16, which comprises a control means for determining the first code and/or the second code in dependence on a demand vector.

21. An automatic system for the automatic business management related characterization of a knowledge object, comprising:
a data processing system,
an interface for receiving a base consisting of a multiplicity of basic vectors and for receiving the knowledge object,
a memory for storing the base,
a characteristic-vector generator for the automatic generation of a characteristic vector,
a reference-code generator for issuing a reference code of the knowledge object, and
a goal-vector generator for issuing a goal vector of the knowledge object; the characteristic-vector generator exhibiting
a projection means for the automatic projection of the knowledge object onto the basic vectors, and
a coordinate-vector generator for automatically determining the business management related characteristic vector as coordinate vector with respect to the base.

22. The automatic system according to claim 21, further comprising a code generator for forming a business management related first code by correlation of the characteristic vector with the goal vector.

23. The automatic system according to claim 21, further comprising a metrics determining means for determining a metric function of the characteristic vector as a business management related second code.

24. The automatic system according to claim 21, further comprising an ID generator for automatically issuing an identification code.

25. The automatic system according to claim 21, further comprising a control means for determining the first code and/or the second code in dependence on a demand vector.
